(19) United States
(12) Patent Application Publication
(10) Pub. No.: US 2020/0104814 A1
(43) Pub. Date: Apr. 2, 2020

(54) DYNAMIC SURCHARGING FOR ATM SYSTEMS

(71) Applicant: FCTI, Inc., Los Angeles, CA (US)

(72) Inventor: Robel Gugsa, Los Angeles, CA (US)

(21) Appl. No.: 16/581,753

(22) Filed: Sep. 25, 2019

Related U.S. Application Data
(60) Provisional application No. 62/738,543, filed on Sep. 28, 2018.

(51) Int. Cl. G06Q 20/10; G07F 19/00

(52) U.S. Cl. CPC G06Q 20/1085; G07F 19/203

(57) ABSTRACT

A system and a method are provided for an automated teller system to dynamically apply and/or vary surcharge fees to individual customers on a transaction by transaction basis. The automated teller system may comprise one or more automated teller machines (ATMs) connected to an application server system by way of a communications network. The application server system manages transactions performed by way of the one or more ATMs. A host computer is connected to the application server system by way of the communication network and managed by a financial institution. The host computer manages the accounts of the individual customers having accounts managed by the financial institution. A fee generator comprising a dynamic surcharging application is stored on a non-transient machine-readable medium of the application server system. The fee generator is configured to apply surcharged fees to individual customer transactions based on predefined criteria.

### CROSS-REFERENCE TO RELATED APPLICATIONS

This Application claims the benefit of U.S. Provisional Patent Application No. 62/738,543, filed on Sep. 28, 2018, titled Dynamic Surcharging for ATM Systems, by inventor Robel Gugsa, the contents of which are expressly incorporated herein by this reference as though set forth in its entirety.

### FIELD OF USE

Embodiments of the present disclosure generally relate to the field of automated teller machines. More specifically, embodiments of the disclosure relate to systems and methods for dynamic surcharging for automated teller machines.

### BACKGROUND

An automated teller machine (ATM) generally enables customers of financial institutions to perform financial transactions, such as cash withdrawals, deposits, funds transfers, or obtaining account information, without a need for direct interaction with banking staff. Typically, customers are identified upon inserting a plastic ATM card, or other acceptable payment card, into the ATM and entering a personal identification number (PIN), which must match the PIN stored in a chip on the card, or in an issuing financial institution's database. ATMs may be placed at any desired location, such as near or inside banks, shopping centers/malls, airports, railway stations, metro stations, grocery stores, gas stations, restaurants, and the like. On-premises ATMs typically are configured to complement financial institutions' services, whereas off-premises ATMs are typically deployed by financial institutions and Independent Sales Organizations (ISOs) at eep

locations where there is a known need for cash. Many financial institutions charge ATM usage fees or surcharges. In some cases, these fees are charged solely to users who are not customers of the financial institution that operates the ATM; in other cases, they apply to all users.

A drawback to conventional surcharge fee implementation methods is that the same surcharge fee is applied to all withdrawal transactions. Although some ATM applications have an ability to modify surcharge fees, the modification is not dynamic. The surcharge fee is applied to all subsequent withdrawal transactions after the modification until the surcharge fee is changed or modified again. What is needed, therefore, is an ATM application that is capable of dynamically varying surcharge fees on a transaction basis.

### SUMMARY OF EMBODIMENTS

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented hereinbelow. It is to be understood that both the following general description and the following detailed description are exemplary and explanatory only and are not restrictive.

To minimize the limitations in the art, and to minimize other limitations that will become apparent upon reading and understanding the present specification, the present specification discloses a new and improved system for dynamic ATM surcharging.

In one embodiment of the present disclosure, after completion of the PIN entry at an ATM or on a mobile device, the cardholder or account holder may be prompted to enter a transaction type, such as withdrawal, transfer, balance inquiry, and the like. When the customer selects a withdrawal transaction, the customer may be prompted to enter a withdrawal amount. The card number may then be checked to determine whether or not the transaction should be surcharged a convenience fee. When a fee is to be charged, the cardholder may be presented with an opportunity to accept or decline the surcharge fee. If the cardholder accepts the fee, the transaction is transmitted to a processor for authorization to dispense the requested withdrawal amount. If the cardholder declines the fee, the transaction will end.

In accordance with the embodiments disclosed herein, the present disclosure is directed to an automated teller machine system that is capable of dynamically varying surcharge fees on a transaction by transaction basis. The automated teller system may comprise one or more ATMs connected to an application server system by way of a communications network. The application server system manages transactions performed by way of the one or more ATMs. A host computer may be connected to the application server system by way of the communication network and managed by a financial institution. The host computer may manage the accounts of the individual customers having accounts managed by the financial institution or other non-financial institute management company. A fee generator comprising a dynamic surcharging application may be stored on a non-transient machine-readable medium of the application server system. The fee generator is configured to apply surcharged fees to individual customer transactions based on predefined criteria. These criteria may include, but are not limited to, specific financial institution, type of card being used, ATM locations, time of day of transaction, customer-specific ATM usage data, and the like.

In one embodiment of the dynamic surcharging system, the dynamic transaction process starts when a cardholder or customer initiates a transaction. The cardholder may be prompted to enter a PIN or other authentication method. The cardholder may select a desired transaction type, such as a cash withdrawal. Once the cardholder selects a desired transaction type, the fee generator checks the card number to determine an appropriate surcharge fee for the transaction. The cardholder may have an opportunity to accept or reject the surcharge fee, after which the transaction may be fulfilled or not depending on whether the cardholder chooses to accept the surcharge fee. It is contemplated that the dynamic transaction process may allow the fee generator to vary surcharge fees to individual transactions based on various desirable criteria, as are described in more detail below, without limitation.

In an embodiment, the customer banks, branches, and/or machines at a given financial institution, and/or the fee generator may lower the surcharge fee.

In an embodiment, the financial institution may also manage the customers' banking and provides additional monetary transaction capabilities to the customers. In this case, it is contemplated that the surcharge fee may be reduced or waived as part of the dynamic charging system. Similarly, when the financial institution providing the ATM does not additionally manage the customers' banking and provide monetary transactions capabilities to said customers, it is contemplated that the surcharge fee may be increased by the dynamic charging systems.

In another embodiment, the dynamic surcharge fee may depend on the type of card (i.e., bank ATM card, pre-paid card, payroll card, and the like) that is used by the customer. In another embodiment, the surcharge fee may depend on the physical location of the ATM. In another embodiment, the surcharge fee depends on the time of day of the transaction. In other embodiments, the dynamic fee generator may apply and/or vary a surcharge fee to individual customer transactions based on the time of day during which the transaction is being performed. For example, the fee generator may determine a higher surcharge fee during peak business/use hours, but may apply a reduced fee, or even waive the fee, during non-peak hours, as desired.

One embodiment may be an ATM device, application, or system that is capable of dynamically varying surcharge fees on a transaction by transaction basis. One basis may be whether the transaction is cardless or with a card.

One embodiment may be an automated teller system to dynamically vary surcharge fees to customers on a transaction by transaction basis, comprising: an application server; one or more automated teller machines connected to the application server by way of a communications network; a dynamic surcharging application stored on a non-transient machine-readable medium of the application server; wherein the dynamic surcharging application is configured to determine a surcharge fee for each of a plurality of transactions on each of the one or more automated teller machines; and wherein the surcharge fee for the transactions is configured to vary from transaction to transaction as determined by the dynamic surcharging application. The automated teller machines may require users to accept the surcharge fee before the transactions are completed. The dynamic surcharging application may vary the surcharge fee based on at least one criteria selected from the group of criteria comprising: location of the ATM; time of day; day of the week, and combinations thereof. Alternatively, the dynamic surcharging application may vary the surcharge fee based on at least one criteria selected from the group of criteria comprising: card user financial data, what financial institution provides the card being used; and combinations thereof. Alternatively, the dynamic surcharging application may vary the surcharge fee based on at least one criteria selected from the group of criteria comprising: location of the ATM; time of day; date of transaction; type of card used during the transaction; what financial institution is controlling the system; customer-specific ATM usage data; card user financial data; what financial institution provides the card being used; and combinations thereof.

Another embodiment may be an automated teller system to dynamically vary surcharge fees to customers on a transaction by transaction basis, comprising: an application server system; one or more automated teller machines connected to the application server system via a communications network; and a dynamic surcharging application stored on a non-transient machine-readable medium of the application server system, wherein the dynamic surcharging application comprises a fee generator; wherein the fee generator is configured to determine a surcharge fee for each of a plurality of transactions on each of the one or more automated teller machines; and wherein the surcharge fee for the transactions is configured to vary from transaction to transaction as determined by the fee generator. The automated teller machines may require users to accept the surcharge fee before the transactions are completed. The fee generator may vary the surcharge fee based on at least one criteria selected from the group of criteria comprising: location of the ATM; time of day; day of the week, and combinations thereof. Alternatively, the fee generator may vary the surcharge fee based on at least one criteria selected from the group of criteria comprising: card user financial data, what financial institution provides the card being used; and combinations thereof. Alternatively, the fee generator may vary the surcharge fee based on at least one criteria selected from the group of criteria comprising: location of the ATM; time of day; date of transaction; type of card used during the transaction; what financial institution is controlling the system; customer-specific ATM usage data; card user financial data; what financial institution provides the card being used; and combinations thereof. The system may further comprise a host computer connected to the application server system via the communications network, wherein the host computer may be managed by a financial institution that controls the dynamic surcharging application. The application server system may comprise at least one processor and may be connected to at least one database server system; wherein the database server system may store a plurality of data related to an operation of the dynamic surcharging application. The plurality of data may comprise one or more of: lists of financial institutions, types of cards that may be used, a list of users that have accounts with the financial institution that controls the host computer, information about the users, ATM locations, and possible surcharge fees that may be charged based on the time of day, peak day usage, peak time usage by day, the type of card being used, the specific financial institution associated with the card being used, location of the ATM, an amount of money a customer has in accounts with the financial institution, a frequency of use of the particular ATMs being used by the user, and what ATMs the user normally uses. The one or more automated teller machines may be installed inside or near a retail location selected from the group consisting of: banks, shopping centers, malls, airports, railway stations, metro stations, grocery stores, gas stations, and restaurants. The host computer may be connected to the application server system and to each of the one or more automated teller machines via the communications network. The dynamic surcharging application may be operated by one or more third-party service providers.

Another embodiment may be a method for applying variable and dynamic surcharge fees during an ATM transaction, comprising the steps: providing an application server system; providing one or more automated teller machines connected to the application server system via a communications network; providing a dynamic surcharging application stored on a non-transient machine-readable medium of the application server system, wherein the dynamic surcharging application comprises a fee generator; wherein the fee generator is configured to determine a surcharge fee for each of a plurality of transactions on each of the one or more automated teller machines; wherein the surcharge fee for the transactions is configured to vary from transaction to transaction as determined by the fee generator; wherein a first transaction is initiated by a first user on a first of the one or more automated teller machines; wherein the first of the one or more automated teller machines prompts the first user to enter a PIN (via card or cardless mobile transaction); verifying the PIN by the first of the one or more automated teller machines; receiving, by the first of the one or more automated teller machines, a request to initiate a cash-based financial transaction; sending the request to the dynamic surcharging application; determining by the fee generator the surcharge fee to be charged to the user; requiring the user to accept or reject the surcharge fee; and completing the transaction if the user accepts the surcharge fee. The fee generator may vary the surcharge fee based on at least one criteria selected from the group of criteria comprising: location of the ATM; time of day; day of the week, and combinations thereof. Alternatively, the fee generator may vary the surcharge fee based on at least one criteria selected from the group of criteria comprising: card user financial data, what financial institution provides the card being used; and combinations thereof. Alternatively, the fee generator may vary the surcharge fee based on at least one criteria selected from the group of criteria comprising: location of the ATM; time of day; date of transaction; type of card used during the transaction; what financial institution is controlling the system; customer-specific ATM usage data; card user financial data; what financial institution provides the card being used; and combinations thereof.

Still other advantages, embodiments, and features of the subject disclosure will become readily apparent to those of ordinary skill in the art from the following description wherein there is shown and described a preferred embodiment of the present disclosure, simply by way of illustration of one of the best modes best suited to carry out the subject disclosure. As it will be realized, the present disclosure is capable of other different embodiments and its several details are capable of modifications in various obvious embodiments all without departing from, or limiting, the scope herein. Accordingly, the drawings and descriptions will be regarded as illustrative in nature and not as restrictive.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration one embodiment of a dynamic surcharge ATM system.

FIG. 2 is a flow block diagram of one embodiment of the dynamic surcharge ATM system.

FIG. 3 is a block diagram of one embodiment of a data processing system that is part of the dynamic surcharge ATM system.

FIG. 4 is an illustration of one embodiment of a dynamic surcharging ATM.

FIG. 5 is an illustration of another embodiment of a dynamic surcharge ATM system.

### DETAILED DESCRIPTION

In the following detailed description of various embodiments, numerous specific details are set forth in order to provide a thorough understanding of various aspects of the embodiments. However, these embodiments may be practiced without some or all of these specific details. In other instances, well-known methods, procedures, and/or components have not been described in detail so as not to unnecessarily obscure aspects of the embodiments.

While multiple embodiments are disclosed, still other will become apparent to those skilled in the art from the following detailed description. As will be realized, these embodiments are capable of modifications in various obvious aspects, all without departing from the spirit and scope of protection. Accordingly, the graphs, figures, and the detailed descriptions thereof, are to be regarded as illustrative in nature and not restrictive. Also, the reference or non-reference to a particular embodiment shall not be interpreted to limit the scope of protection.

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are signify both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware embodiments. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-10% from the indicated number or range of numbers.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

In the following description, certain terminology is used to describe certain features of the embodiments disclosed herein. For instance, the terms “computer”, “computer system”, “computing device”, mobile computing device”, “electronic data processing unit”, or “server” refer to any device that processes information with an integrated circuit chip, including without limitation, personal computers, mainframe computers, workstations, servers, desktop computers, portable computers, laptop computers, embedded computers, wireless devices, including cellular phones, personal digital assistants, tablets, tablet computers, smart phones, portable game players, wearables, smart devices and hand-held computers.

As used herein, the term “Internet” refers to any collection of networks that utilizes standard protocols, whether Ethernet, Token ring, Wi-Fi, asynchronous transfer mode (ATM), Fiber Distributed Data Interface (FDDI), code division multiple access (CDMA), global systems for mobile communications (GSM), long term evolution (LTE), or any combination thereof.

As used herein, the term “website” refers to any document written in a mark-up language including, but not limited to, hypertext mark-up language (HTML) or virtual reality modeling language (VRML), dynamic HTML, extended mark-up language (XML), wireless markup language (WML), or any other computer languages related thereto, as well as to any collection of such documents reachable through one specific Internet Protocol Address or at one specific World Wide Web site, or any document obtainable through any particular Uniform Resource Locator (URL). Furthermore, the terms “webpage,” “page,” “website,” or “site” refers to any of the various documents and resources on the World Wide Web, in HTML/XHTML format with hypertext links to enable navigation from one page or section to another, or similar such resources used on the Internet.

A drawback to conventional surcharge fee implementations is that the same surcharge fee must be applied to all withdrawal surcharge transactions. Although some ATM applications have an ability to modify surcharge fees, the fee is applied to all subsequent withdrawal transactions until the surcharge fee is changed again. Embodiments presented herein provide ATM applications that are capable of dynamically varying surcharge fees on an individual, transaction-by-transaction basis.

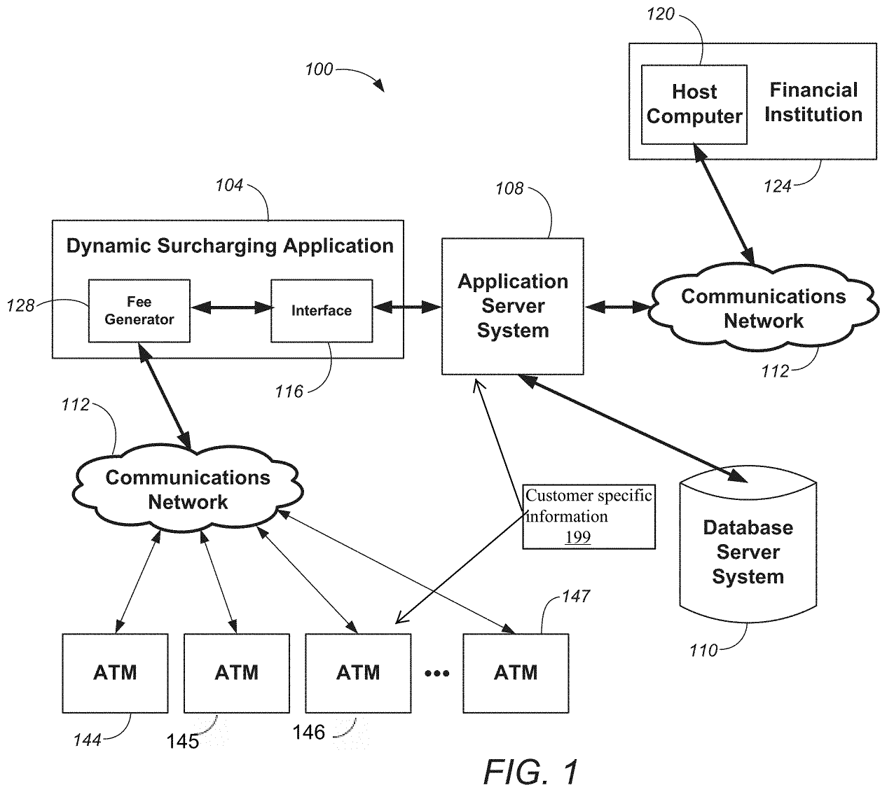

FIG. 1 is an illustration one embodiment of a dynamic surcharge ATM system. FIG. 1 shows one embodiment of a dynamic surcharge ATM system 100 that is configured to dynamically vary surcharge fees on a transaction basis, in accordance with the present disclosure. As shown in FIG. 1, the automated teller system 100 may comprise one or more automated teller machines (ATMs) 144, 145, 146, 147 that may be connected to an application server system 108 via a communications network 112. ATMs 144, 145, 146 may be in-network ATMs and ATM 147 may be an out of network ATM that is connected to the system by agreement between a third party and institution 124. The system 100 may further comprise a host computer 120, which may be managed or controlled by a financial institution 124, and which may be connected to the application server system 108 by the communications network 112. The ATMs 144, 145, 146, 147 may be installed or located at various locations, such as near or inside banks, retail locations, shopping centers/malls, airports, railway stations, metro stations, grocery stores, gas stations, restaurants, and the like.

Some of the ATMs 144, 145, 146 may be managed by a financial institution 124 that provides monetary transactions capability to individual customers. For example, the ATM 144, 145, 146 may dispense cash to customers seeking to withdraw money from a personal account managed by the financial institution 124, or the customers may deposit funds into the ATMs 144, 145, 146 and have corresponding monetary credits added to their personal accounts. In one embodiment, the host computer 120 is configured to manage the accounts of customers of the financial institution 124. ATM 147 may be managed by another, third party financial (out of network) institution, but still provides monetary tractions, such as withdrawals, and for some users, deposits. The third-party owner and controller of ATM 147 may agree to have the ATM 147 be part of the dynamic surcharging system. The institution 124 and third-party institution may then split the dynamic surcharge fees collected. Other than providing a dynamic surcharge for ATM 147, ATM 147 the transactions are not managed by institution 124.

The application server system 108 may be a server, server computer, or the like, that manages transactions performed on the individual ATMs 144, 145, 146. A dynamic surcharging application 104 may be stored on a non-transient machine-readable medium (i.e., a memory) of the application server system 108, which may comprise at least one processor and may be connected to at least one database server system 110. Generally, the database server system 110 may (at least) store data specific to the operation of the dynamic surcharging application 104, such as lists of financial institutions, types of cards that may be used, a list of users (and information about those users) that have accounts with the financial institution that controls the host computer 120 and/or application server system 108 ATM locations, specific surcharge fees that may be charged based on the time of day, peak day usage, peak time usage by day, the type of card being used, the specific financial institution associated with the card being used, location of the ATM, the amount of money the customer has in accounts with institution 124, the frequency of use of the particular ATMs being used by the user, what ATMs the user normally uses and whether this particular ATM is one of the regular ones or one of the more infrequent ones, and the like.

In one embodiment the application server system 108, dynamic surcharging application 104, and database 110 may reside on the ATMs 144, 145, 146. In one embodiment, the Application server system 108 and database 110 may be cloud based. In another embodiment, the dynamic charging application 104 and database 110 may reside on the host computer 120. In one embodiment, the dynamic surcharging application 104 may comprise an interface 116 that provides access to a fee generator 128. In one embodiment, the dynamic surcharging application 104 may be stored on the memory of the application server system 108, and the interface 116 is a software application which comprises a portion of the dynamic surcharging application 104, thereby providing access to the fee generator 128.

In one embodiment, the dynamic surcharging application 104 is stored on the memory of the database server system 110, and the interface 116 enables interaction between the application server system 108 and the dynamic surcharging application 104 on the database server system 110.

In some embodiments, the dynamic surcharging application 104 may be part of a group of services operated by one or more third-party service providers. In such embodiments, the interface 116 may comprise a connection over the communications network 112, such as an Internet connection, whereby the application server system 108 may send requests to, and receive services from, the one or more third-party service providers.

The fee generator 128 may be configured to apply and/or vary surcharge fees to individual customer transactions based on various desirable criteria, including, but not limited to, the specific financial institution that is controlling the dynamic surcharging, the types of cards being used at the ATM, ATM locations, day of the transaction, the time of day of transaction, customer-specific ATM usage data, card user data, and what financial institution provides the card being used.

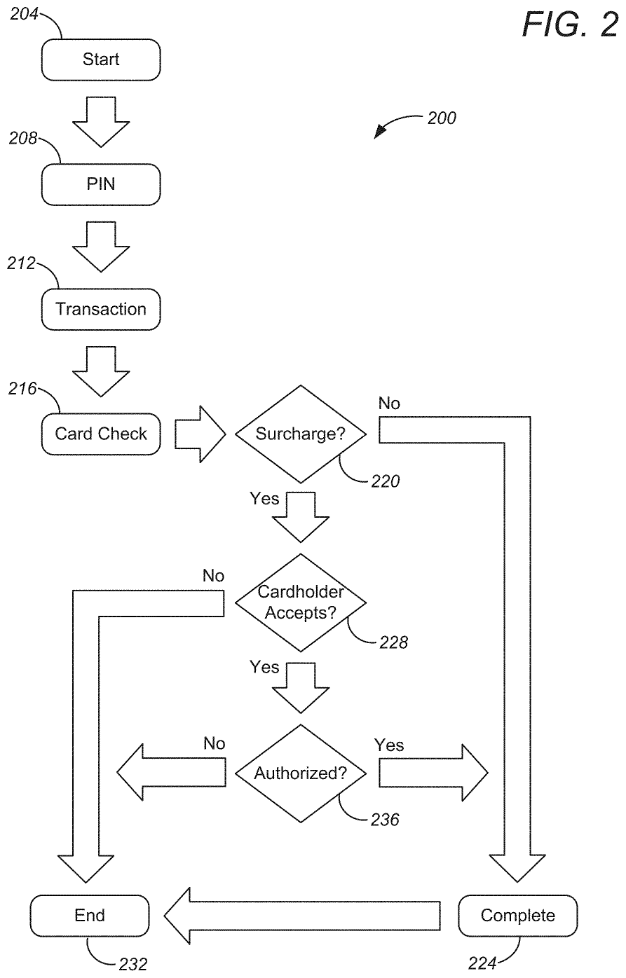

FIG. 2 is a flow block diagram of one embodiment of the dynamic surcharge ATM system. The dynamic surcharge ATM transaction process 200 may begin at a start step 204 wherein a cardholder or a customer initiates a transaction. The cardholder may initiate the transaction by inserting a card into an ATM or by way of various other transaction initiation methods, such as entering a PIN or other identification via a keypad or selecting a transaction type as displayed via the interface.

Once the dynamic transaction process 200 is initiated with start 204, the cardholder may be prompted to enter a personal identification number (PIN) 208. It is contemplated that the cardholder enters the PIN by typing on a keyboard or a touchscreen of the ATM. After the cardholder enters the PIN, the cardholder's PIN may be verified by comparing it with a PIN stored in a chip on the card or that is stored in a database associated with the issuing financial institution 124, such as the host computer 120. In another embodiment, the security code may be entered via a mobile device and the transaction may be cardless.

After the entered PIN is determined to be valid, the cardholder may be prompted to select a desired transaction 212 type. Typically, the cardholder may be prompted to withdraw cash, deposit funds, transfer funds, or inquire about a current account balance. The exact transactions available may depend on whether the user and card have an affiliation with the financial institution that is controlling the ATM. Typically, more options are offered to users that have an account with the financial institution that controls the ATM. The transaction types presented to the cardholder may also depend upon the transactions offered by the financial institution 124 that manages the cardholder's account.

Once the cardholder selects a desired transaction type, the process 200 may then comprise a card check 216, wherein the fee generator and/or dynamic surcharging application determines whether a surcharge should be charged, and if so, how much that surcharge will be. For example, when the cardholder selects a cash withdrawal, the fee generator and/or dynamic surcharging application may determine that a surcharged convenience fee is, or is not, proper 220. The fee generator and/or dynamic surcharging application may make this decision by evaluating such factors as: whether the card user is with the financial institution controlling the ATM, what day and time it is, time of day, peak day usage, peak time usage by day, the type of card being used, the specific financial institution associated with the card being used, and the location of the ATM.

If a surcharged fee is determined to be unnecessary the transaction selected by the cardholder is fulfilled 224 without any surcharge fee. After fulfilling (or denying) the desired transaction, the dynamic transaction process 200 may be completed or terminated 232, wherein the customer's card is returned, and/or a transaction receipt is issued to the customer. If the transaction is cardless, then the receipt may be emailed or texted.

The fee generator and/or dynamic surcharging application may apply and/or vary surcharge fees to individual customer transactions based on various criteria. In some embodiments, the fee generator and/or dynamic surcharging application may be configured to perform a geomapping-type of surcharging, wherein surcharged fees are based on specific location data. For example, in some embodiments, the fee generator and/or dynamic surcharging application may apply a surcharge fee to a transaction by a customer associated with one or more third-party financial institutions, other than the financial institution that manages the ATM being used by the customer. In some embodiments, no surcharge is charged to in-network users and a relatively higher fee may be charged to a customer that is withdrawing cash from an ATM whose account is managed by a first third-party financial institution as compared to a customer that uses a card managed by a second third-party financial institution. Further, the fee generator and/or dynamic surcharging application may apply a higher surcharge fee to individual customer transactions performed at an ATM located within desirable retail locations, such as airports, shopping centers, malls, retail stores, convenience stores, airports, railway stations, metro stations, grocery stores, gas stations, restaurants, standalone locations, and the like. This

In some embodiments, the fee generator and/or dynamic surcharging application may apply and/or vary a surcharge fee to an individual customer transaction based on the type of card being used for the transaction. For example, the fee generator and/or dynamic surcharging application may charge a higher or lower surcharge fee when the customer is using a credit card, a debit card, a gift card, a foreign ATM card, an ATM only card, a pre-paid card, a payroll card, or a credit union card.

In some embodiments, the fee generator and/or dynamic surcharging application may apply and/or vary a surcharge fee to individual customer transactions based on the time of day during which the transaction is being performed. For example, the fee generator and/or dynamic surcharging application may charge a higher surcharge fee during peak business hours, but may apply a reduced fee, or even waive the fee, during non-peak hours, as desired.

In some embodiments, FIG. 1 shows the dynamic surcharging application 104 may include a feedback loop whereby customer-specific information 199 is collected by specific ATMs 144, 145, 146 and conveyed to a central location via the communications network 112, such as a financial institution 124. The financial institution 124 may be the same financial institution 124 that manages the ATM 144, 145, 146, or a third-party, non-managing financial institution. The customer-specific information 199 may include, but is not limited to, the time of day the customer uses the specific ATM 144, 145, 146, the frequency with which the customer uses the ATM 144, 145, 146, the financial institution with which the customer is affiliated, balance data pertaining to the customer, and the like. In some embodiments, the customer-specific information 199 may include specific locations and mapping of where the customer uses the ATMs 144, 145, 146, 147, how often the customer uses ATMs 144, 145, 146, 147, the amount of cash the customer withdraws, as well as whether or not the customer engages in regular use of ATMs 144 145, 146, 147, or uses ATMs 144 145, 146, 147 on an occasional or emergency basis. The customer-specific information 199 may then be used to determine new surcharging criteria that the fee generator 128 may use for specific customers using specific ATMs 144, 145, 146, 147.

In some embodiments the dynamic fee system 100 may eliminate the fee for users that frequent an ATM, thus waiving the normal fees and or enhanced fees that would typically be charged. Alternatively, the system 100 may raise fees for customers that have low account balances or balances under a certain threshold, in order to incentivize more savings. Alternatively, customers with large balance or balances over a certain threshold may not be charged any fees. In some embodiments, the system 100 may raise the fee for customers of a specific rival institutions.

In some embodiments, the feedback loop further enables the financial institution 124 to target specific customers for incentives. For example, the fee generator 128 may reduce surcharge fees charged to a particular customer that utilizes a specific ATM 144 a particular number of times during a predetermined time period. Or may eliminate fees for every 4^{th} or 5^{th} (etc.) use of the ATM. Further, in some embodiments, the fee generator 128 may dynamically change the charged surcharge fee based on a type of use of the ATM 144, such as whether the transaction type selected by the customer is a withdrawal, account balance check, or deposit.

In some embodiments, customer-specific information 199 may be utilized by financial institutions 124 for demographic, marketing, and data tracking purposes. In such embodiments, financial institutions 124 may monitor the times during which customers tend to use the ATMs 144, 145, 146, 147, how much cash the customers are withdrawing, as well as identifying account information pertaining to the customers. In this manner, financial institutions 124 may acquire detailed information about their current and potential customer bases. It is contemplated that the customer-specific information 199 can be sold/purchased so as to provide consumer-related information to retailers that have the ATMs 144, 145, 146, 147, in their possession.

It is further contemplated that, in some embodiments, the collected customer-specific information can be used for targeted marketing to specific customers using the ATMs 144. For example, in an instance wherein the customer-specific information suggests that a particular customer using an ATM 144 is likely leaving a drinking establishment, various food products or transportation services can be marketed to the customer during using the ATM 144. Indeed, the ATM receipts may have a pre-printed or contemporaneously printed coupon. This may dynamic advertising to promote products based on in-store purchase data collected from establishment POS (point of sale) system. The promotion can vary by user or the surcharge fee can be waived or lowered if the card holder opts-in to watch specific promotion or advertisement during the transaction.

As shown in FIG. 2, once the fee generator determines that a surcharged fee is proper, the dynamic transaction process 200 advances to a step 228 wherein the cardholder may be presented with a description of the fee to be surcharged and an option to accept or decline the fee. If the cardholder chooses to decline the fee, the dynamic transaction process 200 immediately advances to the end step 232 without performing the selected transaction. Alternatively, if the cardholder accepts the proposed fee, the dynamic transaction process 200 advances to an authorization step 236, wherein authorization to perform the requested transaction may be verified. If the requested transaction fails to be authorized at step 236, the process 200 immediately advances to the end step 232 without performing the selected transaction. The requested transaction might not be authorized due to insufficient funds, incorrect PIN, exceeds withdrawal limit, is a restriction transaction, restricted card, or the card was reported as lost or stolen, or the card is expired. If the requested transaction is found to be authorized at step 236, the process 200 advances to step 224, wherein the transaction is completed, and the surcharged fee is applied to the cardholder's account. After fulfilling the selected transaction, the process 200 moves to the end step 232, wherein the customer's card is returned, and/or a transaction receipt is issued to the customer.

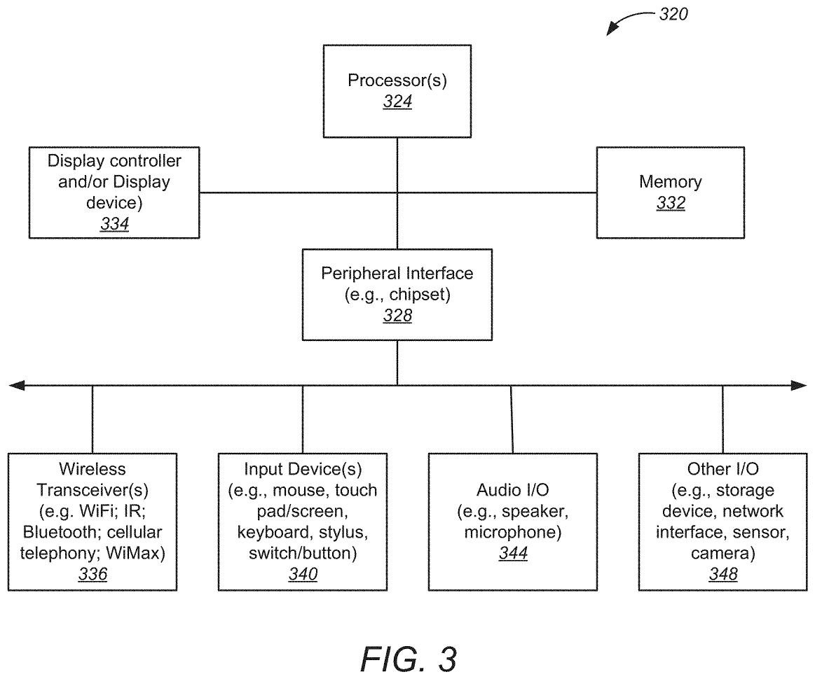

FIG. 3 is a block diagram of one embodiment of a data processing system that is part of the dynamic surcharge ATM system. FIG. 3 is a block diagram illustrating an exemplary data processing system 320 that may be used with the automated teller system 100 to perform any of the processes or methods described herein. The data processing system 320 may represent a desktop, a tablet, a server, a mobile phone, a media player, a personal digital assistant (PDA), a personal communicator, a network router or hub, a wireless access point (AP) or repeater, a set-top box, or a combination thereof.

In one embodiment, illustrated in FIG. 3, the data processing system 320 includes a processor 324 and a peripheral interface 328, also referred to as a chipset, which may couple various components to the processor 324, including, without limitation, a memory 332 and devices 336-348 by way of a bus or an interconnect. The processor 324 may represent a single processor or multiple processors with a single processor core or multiple processor cores included therein. The processor 324 may represent one or more general-purpose processors such as a microprocessor, a central processing unit (CPU), and the like. More particularly, the processor 324 may be a complex instruction set computing (CISC) microprocessor, reduced instruction set computing (RISC) microprocessor, very long instruction word (VLIW) microprocessor, a processor implementing other instruction sets, or processors implementing a combination of instruction sets. The processor 324 may also be one or more special-purpose processors such as an application specific integrated circuit (ASIC), a field programmable gate array (FPGA), a digital signal processor (DSP), a network processor, a graphics processor, a network processor, a communications processor, a cryptographic processor, a co-processor, an embedded processor, or any other type of logic capable of processing instructions. The processor 324 may be configured to execute instructions for performing the operations and steps discussed herein.

The peripheral interface 328 may include a memory control hub (MCH) and an input output control hub (ICH). Peripheral interface 328 may include a memory controller (not shown) that communicates with a memory 332. The peripheral interface 328 may also include a graphics interface that communicates with graphics subsystem 334, which may include a display controller and/or a display device. The peripheral interface 328 may communicate with the graphics device 334 by way of an accelerated graphics port (AGP), a peripheral component interconnect (PCI) express bus, or any other type of interconnects.

The terms MCH and ICH may also be referred to as a Northbridge and Southbridge, respectively. As used herein, the terms MCH, ICH, Northbridge and Southbridge are intended to be interpreted broadly to cover various chips that perform functions including passing interrupt signals toward a processor.

In some embodiments, the MCH may be integrated with the processor 324. In such a configuration, the peripheral interface 328 operates as an interface chip performing some functions of the MCH and ICH. Furthermore, a graphics accelerator may be integrated within the MCH or the processor 324.

The memory 332 may include one or more volatile storage (or memory) devices, such as random access memory (RAM), dynamic RAM (DRAM), synchronous DRAM (SDRAM), static RAM (SRAM), or other types of storage devices. The memory 332 may store information including sequences of instructions that are executed by the processor 324, or any other device. For example, executable code and/or data of a variety of operating systems, device drivers, firmware (e.g., input output basic system or BIOS), and/or applications may be loaded into memory 332 and executed by the processor 324. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

The peripheral interface 328 may provide an interface to input-output (I/O) devices, such as the devices 336-348, including wireless transceiver(s) 336, input device(s) 340, audio I/O device(s) 344, and other I/O devices 348. The wireless transceiver 336 may be a WiFi transceiver, an infrared transceiver, a Bluetooth transceiver, a WiMax transceiver, a wireless cellular telephony transceiver, a satellite transceiver (e.g., a global positioning system (GPS) transceiver) or a combination thereof. Input device(s) 340 may include a mouse, a touch pad, a touch sensitive screen (which may be integrated with display device 334), a pointer device such as a stylus, and/or a keyboard (e.g., physical keyboard or a virtual keyboard displayed as part of a touch sensitive screen). For example, the input device 340 may include a touch screen controller coupled with a touch screen. The touch screen and touch screen controller may, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

Audio I/O 344 may include a speaker and/or a microphone to facilitate voice-enabled functions, such as voice recognition, voice replication, digital recording, and/or telephony functions. Other optional devices 348 may include a storage device (e.g., a hard drive, a flash memory device), universal serial bus (USB) port(s), parallel port(s), serial port(s), a printer, a network interface, a bus bridge (e.g., a PCI-PCI bridge), sensor(s) (e.g., a motion sensor, a light sensor, a proximity sensor, etc.), or a combination thereof. Optional devices 348 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips.

Note that while FIG. 3 illustrates various components of a data processing system, it is not intended to represent any particular architecture or manner of interconnecting the components; as such details are not germane to embodiments of the present disclosure. It should also be appreciated that network computers, handheld computers, mobile phones, and other data processing systems, which have fewer components or perhaps more components, may also be used with the various embodiments disclosed herein.

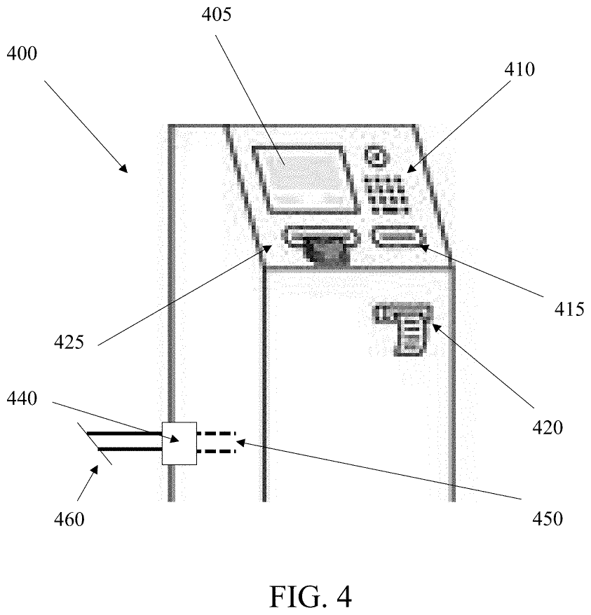

FIG. 4 is an illustration of one embodiment of a dynamic surcharging ATM. FIG. 4 shows that the ATM 400 may comprise a display 405, an interface 410, a card slot 415, a receipt slot 420, money slot 425, and electronic data processing unit 440, which may comprise wireless transceiver 450 and/or hard wire connection 460. The electronic data processing unit may 440 may be in communication with the dynamic surcharging application through a communications network. The electronic data processing unit 440 may display to the user the dynamic surcharge, if needed, on the display 405. The user may then use the interface 410 (which may be tactile buttons or touchpad (soft keys)) to accept or reject the surcharge.

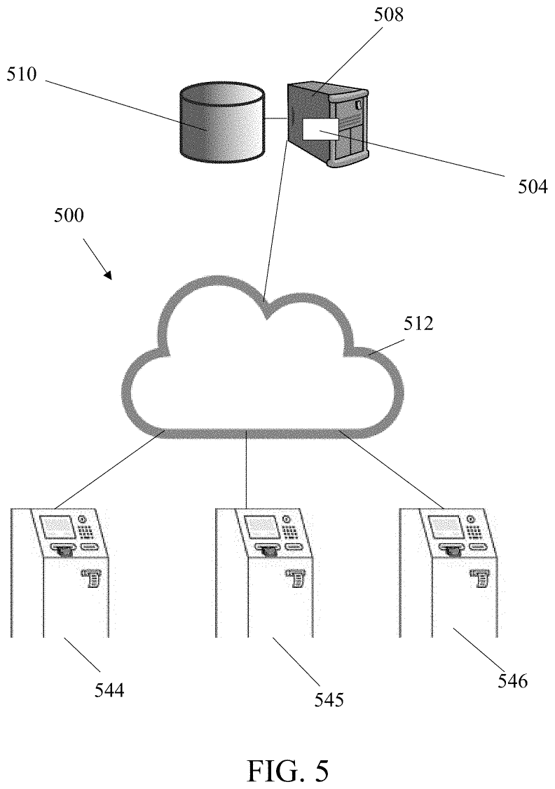

FIG. 5 is an illustration of another embodiment of a dynamic surcharge ATM system. As shown in FIG. 5 the dynamic surcharge ATM system 500 may comprise a host server, database 510, dynamic surcharging application 504, cloud communication network 512 and networked ATMs 544, 545, 546. The host server 508 preferably manages transactions performed on the ATMs 544, 545, 546. A dynamic surcharging application 504 may be stored on a non-transient machine-readable medium (i.e., a memory) of the server 508, which may comprise at least one processor and may be connected to at least one database 510. Generally, the database 510 may (at least) store data specific to the operation of the dynamic surcharging application 504, such as lists of financial institutions, types of cards that may be used, a list of users (and information about those users) that have accounts with the financial institution that controls the host server 508, specific surcharge fees that may be charged based on the time of day, peak day usage, peak time usage by day, the type of card being used, the specific financial institution associated with the card being used, location of the ATM, the amount of money the customer has in accounts with the managing institution, the frequency of use of the particular ATMs being used by the user, what ATMs the user normally uses and whether this particular ATM is one of the regular ones or one of the more infrequent ones, and the like.

In one embodiment the server 508, dynamic surcharging application 504, and database 510 may reside on the ATMs 544, 545, 546. In one embodiment, the server 508 and database 510 may be cloud based. In another embodiment, the dynamic charging application 504 and database 510 may reside on the host server 508. In one embodiment, the dynamic surcharging application 504 may comprise a fee generator. The fee generator may be configured to apply and/or vary surcharge fees to individual customer transactions based on various desirable criteria, including, but not limited to, the specific financial institution that is controlling the dynamic surcharging, the types of cards being used at the ATM, ATM locations, day of the transaction, the time of day of transaction, customer-specific ATM usage data, card user data, and what financial institution provides the card being used.

Some portions of the preceding detailed descriptions have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it should be appreciated that throughout the present disclosure, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display devices.

The techniques shown in the figures can be implemented using code and data stored and executed on one or more electronic devices. Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals).

The processes or methods depicted in the figures may be performed by processing logic that comprises hardware (e.g. circuitry, dedicated logic, etc.), firmware, software (e.g., embodied on a non-transitory computer readable medium), or a combination thereof. Although the processes or methods are described above in terms of some sequential operations, it should be appreciated that some of the operations described may be performed in a different order. Moreover, some operations may be performed in parallel rather than sequentially.

While the present disclosure has been described in terms of particular variations and illustrative figures, those of ordinary skill in the art will recognize that the disclosure is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

What is claimed is:

1. An automated teller system to dynamically vary surcharge fees to customers on a transaction by transaction basis, comprising:
an application server;
one or more automated teller machines connected to said application server by way of a communications network;
a dynamic surcharging application stored on a non-transient machine-readable medium of said application server;
wherein said dynamic surcharging application is configured to determine a surcharge fee for each of a plurality of transactions on each of said one or more automated teller machines; and
wherein said surcharge fee for said transactions is configured to vary from transaction to transaction as determined by said dynamic surcharging application.

2. The system of claim 1, wherein said one or more automated teller machines require users to accept said surcharge fee before said transactions are completed.

3. The system of claim 1, wherein said dynamic surcharging application varies said surcharge fee based on at least one criteria selected from the group of criteria consisting of: location of the ATM; time of day; day of the week, and combinations thereof.

4. The system of claim 1, wherein said dynamic surcharging application varies said surcharge fee based on at least one criteria selected from the group of criteria consisting of: card user financial data, what financial institution provides the card being used; and combinations thereof.

5. The system of claim 1, wherein said dynamic surcharging application varies said surcharge fee based on at least one criteria selected from the group of criteria consisting of: location of the ATM; time of day; date of transaction; type of card used during the transaction; what financial institution is controlling the system; customer-specific ATM usage data; card user financial data; what financial institution provides the card being used; and combinations thereof.

6. An automated teller system to dynamically vary surcharge fees to customers on a transaction by transaction basis, comprising:
an application server system;
one or more automated teller machines connected to said application server system via a communications network; and
a dynamic surcharging application stored on a non-transient machine-readable medium of the application server system, wherein said dynamic surcharging application comprises a fee generator;
wherein said fee generator is configured to determine a surcharge fee for each of a plurality of transactions on each of said one or more automated teller machines; and
wherein said surcharge fee for said transactions is configured to vary from transaction to transaction as determined by said fee generator.

7. The system of claim 6, wherein said one or more automated teller machines require users to accept said surcharge fee before said transactions are completed.

8. The system of claim 6, wherein said fee generator varies said surcharge fee based on at least one criteria selected from the group of criteria consisting of: location of the ATM; time of day; day of the week, and combinations thereof.

9. The system of claim 6, wherein said fee generator varies said surcharge fee based on at least one criteria selected from the group of criteria consisting of: card user financial data, what financial institution provides the card being used; and combinations thereof.

10. The system of claim 6, wherein said fee generator varies said surcharge fee based on at least one criteria selected from the group of criteria consisting of: location of the ATM; time of day; date of transaction; type of card used during the transaction; what financial institution is controlling the system; customer-specific ATM usage data; card user financial data; what financial institution provides the card being used; and combinations thereof.

11. The system of claim 6, further comprising a host computer connected to said application server system via said communications network, wherein said host computer is managed by a financial institution that controls said dynamic surcharging application.

12. The system of claim 11, wherein said application server system comprises at least one processor and is connected to at least one database server system; wherein said database server system stores a plurality of data related to an operation of said dynamic surcharging application.

13. The system of claim 12, wherein said plurality of data comprises one or more of: lists of financial institutions, types of cards that may be used, a list of users that have accounts with said financial institution that controls said host computer, information about said users, ATM locations, and possible surcharge fees that may be charged based on the time of day, peak day usage, peak time usage by day, the type of card being used, the specific financial institution associated with the card being used, location of the ATM, an amount of money a customer has in accounts with said financial institution, a frequency of use of the particular ATMs being used by the user, and what ATMs the user normally uses.

14. The automated teller system of claim 13, wherein said one or more automated teller machines are installed at one or more retail locations selected from the group of retail locations consisting of: banks; shopping centers; malls; airports; railway stations; metro stations; grocery stores; gas stations; and restaurants.

15. The automated teller system of claim 14, wherein said host computer is connected to the application server system and to each of said one or more automated teller machines via said communications network.

16. The automated teller system of claim 6, wherein said dynamic surcharging application may be operated by one or more third-party service providers.

17. A method for applying variable and dynamic surcharge fees during an ATM transaction, comprising the steps:
providing an application server system;
providing one or more automated teller machines connected to said application server system via a communications network;
providing a dynamic surcharging application stored on a non-transient machine-readable medium of the application server system, wherein said dynamic surcharging application comprises a fee generator;
wherein said fee generator is configured to determine a surcharge fee for each of a plurality of transactions on each of said one or more automated teller machines;
wherein said surcharge fee for said transactions is configured to vary from transaction to transaction as determined by said fee generator;
wherein a first transaction is initiated by a first user on a first of said one or more automated teller machines;
wherein said first of said one or more automated teller machines prompts said first user to enter a PIN;
verifying said PIN by said first of said one or more automated teller machines;
receiving, by said first of said one or more automated teller machines, a request to initiate a cash-based financial transaction;
sending said request to said dynamic surcharging application;
determining by said fee generator said surcharge fee to be charged to said user;
requiring said user to accept or reject said surcharge fee; and
completing said transaction if said user accepts said surcharge fee.

18. The system of claim 17, wherein said fee generator varies said surcharge fee based on at least one criteria selected from the group of criteria consisting of: location of the ATM; time of day; day of the week, and combinations thereof.

19. The system of claim 17, wherein said fee generator varies said surcharge fee based on at least one criteria selected from the group of criteria consisting of: card user financial data, what financial institution provides the card being used; and combinations thereof.

20. The system of claim 17, wherein said fee generator varies said surcharge fee based on at least one criteria selected from the group of criteria consisting of: location of the ATM; time of day; date of transaction; type of card used during the transaction; what financial institution is controlling the system; customer-specific ATM usage data; card user financial data; what financial institution provides the card being used; and combinations thereof.
